(19) United States
(12) Patent Application Publication
(10) Pub. No.: US 2011/0094439 A1
(43) Pub. Date: Apr. 28, 2011

(54) COLD GAS SPRAYING SYSTEM

(75) Inventor: Oliver Stier, Berlin (DE)

(73) Assignee: Siemens Aktiengesellschaft, Munich (DE)

(21) Appl. No.: 12/736,476

(22) PCT Filed: Mar. 24, 2009
(86) PCT No.: PCT/EP2009/053462

§ 371 Date: Oct. 12, 2010

(30) Foreign Application Priority Data
Apr. 11, 2008 (DE) 10 2008 019 682.7

(51) Int. Cl. B05C 19/02

(52) U.S. Cl. 118/58

(57) ABSTRACT

A gas heating device is connected to a stagnation chamber having a Laval nozzle discharging a gas stream with incorporated particles at an ultrasonic speed, thus forming a cold gas spraying system capable of coating a surface by the accelerated particles. To achieve an better layer quality, at least one section of the cold gas spraying system, downstream of the gas heating device, is thermally protected by lining or forming the internal wall of the section with a ceramic insulation material having a heat conductivity of less than 20 W/Km to separate the internal wall of the section from the gas stream. A sleeve may be used, a portion of which is cylindrical and another portion which is a truncated conical section; the cylindrical section being inserted into the stagnation chamber and the conical section being inserted into the convergent subsection of the Laval nozzle.

### CROSS REFERENCE TO RELATED APPLICATIONS

This application is the U.S. national stage of International Application No. PCT/EP2009/053462, filed Mar. 24, 2009 and claims the benefit thereof. The International Application claims the benefits of German Application No. 10 2008 019 682.7 filed on Apr. 11, 2008, both applications are incorporated by reference herein in their entirety.

### BACKGROUND

Described below is a cold gas spraying system like that marketed, for example, by CGT Cold Gas Technology GmbH under the product name Kinetiks® 4000 Cold Spray System. The previously known cold gas spraying system has a gas heating device for heating a gas. Connected to the gas heating device, there is a stagnation chamber which is connected on the output side to a Laval nozzle. As is known, Laval nozzles have a converging subsection, a nozzle neck following the converging subsection, and a diverging subsection following the nozzle neck. On the output side, the Laval nozzle discharges a gas stream containing particles at supersonic speed. Cold gas spraying systems of the described type can, for example, be used in order to produce a coating on a surface by using the accelerated particles.

### SUMMARY

An aspect is to provide a cold gas spraying system with which an even better layer quality than before can be achieved when producing a coating.

Accordingly, there is at least one section of the cold gas spraying system lying behind the gas heating device—as seen in the gas flow direction—which is thermally protected by being clad on the inner wall side with a ceramic insulation material which has a thermal conductivity (heat conductivity) of less than 20 watts per kelvin per meter (20 W/Km), or the inner wall may be formed of such a material.

The thermal conductivity of an insulation material may be specified for a temperature range of between 30 and 100° C. and specifically, as mentioned, in W/(K*m).

An essential advantage of this cold gas spraying system is that higher flow speeds of the gas stream and therefore higher particle speeds can be achieved with it than in the case of previously known cold gas spraying systems. This is specifically attributable to the fact that, owing to providing thermal insulation of at least one section lying behind the gas heating device as seen in the gas flow direction, higher stagnation temperatures of the gas can be achieved inside the cold gas spraying system than before. It has been discovered that the flow speeds achievable against atmospheric pressure, both that of the gas stream and that of the particles contained in it, depend more on the stagnation temperature of the gas and less on the stagnation pressure of the gas. The system addresses this by making it possible to achieve even higher stagnation temperatures than before by one or more sections lying behind the gas heating device being thermally insulated or thermally protected in a controlled way, in order to allow even higher temperatures in these sections without damage to system parts of the cold gas spraying system. In other words, reaching higher stagnation temperatures by additional thermal insulation may be used to achieve higher flow speeds of the particles and therefore in turn higher coating qualities.

The insulation material is preferably formed by one or more of the following materials or at least also contains one or more of them: porcelains, steatites, cordierite ceramics; aluminum oxide, in particular zirconium-reinforced; aluminum silicate; aluminum titanate; zirconium oxide, in particular stabilized variants; oxides of magnesium, beryllium or titanium; silicon nitride; porous silicon carbide, in particular nitride-bonded or recrystallized.

According to an embodiment, the cladding is formed by an insert formed entirely or in part of the insulating material and is placed in the thermally protected section of the cold gas spraying system so that it separates the inner wall of the section from the gas stream. The effect achieved by this configuration is that, in the event of wear to the thermal insulation material, it can be replaced particularly easily and therefore advantageously.

As an alternative, the cladding may be formed by a coating of the insulation material, which is applied on the inner wall of the section and separates the inner wall of the section from the gas stream.

The thermally protected section particularly preferably lies in the converging subsection of the Laval nozzle, in order to avoid thermal stress and deformation of this subsection which is relevant to the jet formation and acceleration of the gas.

At least a part of the insert is preferably formed by a conical, in particular frustoconical sleeve, which is placed in the converging subsection of the Laval nozzle. With such a configuration, particularly easy replacement of the insert is possible in the event of material wear.

As an alternative, the thermally protected section may lie in the stagnation chamber.

The thermally protected section preferably extends from the stagnation chamber out of the stagnation chamber into the converging part of the Laval nozzle. For example, the thermal insulation is achieved by an insert that is formed by a sleeve which in one section is cylindrical and in another section is conical, in particular frustoconical, the cylindrical section of which is placed in the stagnation chamber and the conical section of which is placed in the converging subsection of the Laval nozzle. The thermally protected section may also extend into the nozzle neck and/or through it.

With a view to economical maintenance of the cold gas spraying system, it is regarded as advantageous that the stagnation chamber can be opened and the insert and the stagnation chamber are configured so that the insert can be taken out of the stagnation chamber and replaced.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic diagram of a first exemplary embodiment of a cold gas spraying system, in which the converging subsection of the Laval nozzle of the cold gas spraying system is thermally protected,

FIG. 2 is a schematic diagram of a second exemplary embodiment of a cold gas spraying system, in which the stagnation chamber is thermally protected,

FIG. 3 is a schematic diagram of a third exemplary embodiment of a cold gas spraying system, in which a section of the stagnation chamber of the cold gas spraying system and the adjacent converging subsection of the Laval nozzle are thermally protected, and

FIG. 4 is a schematic diagram of an exemplary embodiment of a cold gas spraying system, in which the thermally protected section of the stagnation chamber extends over the converging subsection of the Laval nozzle into the diverging subsection of the Laval nozzle.

### DETAILED DESCRIPTION OF THE PREFERRED EMBODIMENT

Reference will now be made in detail to the preferred embodiments, examples of which are illustrated in the accompanying drawings, wherein like reference numerals are used for components which are identical or similar.

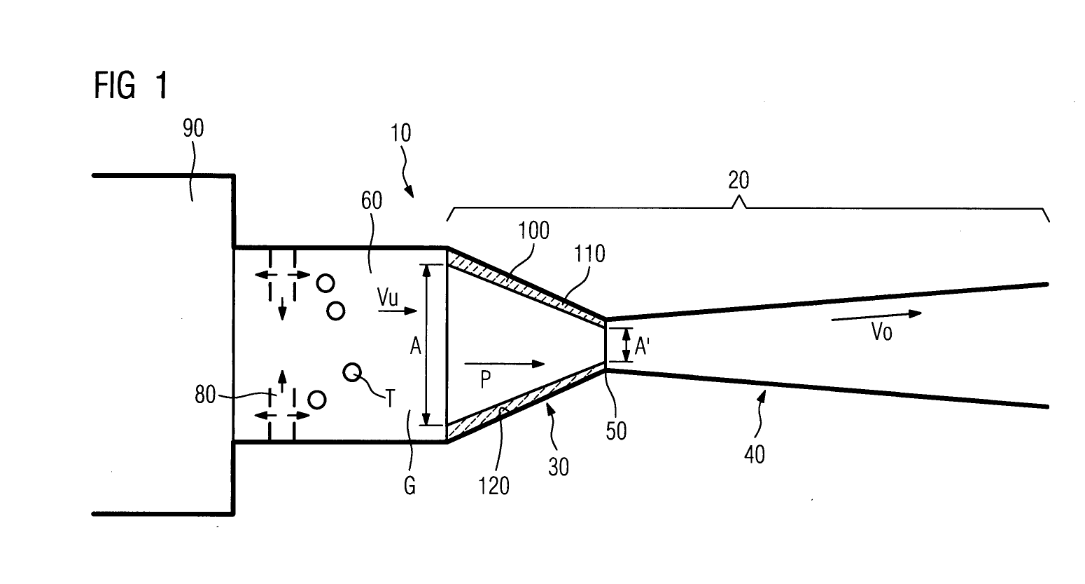

FIG. 1 shows a cold gas spraying system 10, which is equipped with a Laval nozzle 20. The Laval nozzle 20 has a converging subsection 30 and a diverging subsection 40. The converging subsection 30 and the diverging subsection 40 are separated from one another by a nozzle neck 50, in which the cross section of the Laval nozzle 20 is minimal.

A stagnation chamber 60 is connected to the converging subsection 30 of the Laval nozzle 20. As can be seen in FIG. 1, the cross-sectional area A of the stagnation chamber 60 is very much greater than the cross-sectional area A′ in the region of the nozzle neck 50, so that significant acceleration of a gas stream P passing through the Laval nozzle 20 takes place in the region of the nozzle neck 50 and in the subsequent diverging subsection 40. The relatively low gas flow speed (0≈Mach number<<1) in the stagnation chamber 60 is denoted by the reference Vu and the supersonic high gas flow speed (Mach number>1) in the subsection 40 is denoted by the reference Vo.

A particle feed device 80 extends into the stagnation chamber 60 and feeds particles T into the gas G contained in the stagnation chamber 60. In the exemplary embodiment according to FIG. 1, the particles T are fed laterally from the edge into the stagnation chamber 60; this, however, is to be understood merely as an example: the particles T may be fed into the stagnation chamber 60 centrally or at geometrical angles other than those represented in FIG. 1.

Arranged before the stagnation chamber 60 as seen in the gas flow direction, there is a gas heating device 90 which heats the gas G before it enters the stagnation chamber 60 and the Laval nozzle 20.

The cold gas spraying system 10 according to FIG. 1 can be operated as follows:

The particles T are fed into the gas G contained in the stagnation chamber 60 by the particle feed device 80. Owing to the large cross section A in the stagnation chamber 60, the gas flow speed Vu of the gas stream P from the stagnation chamber 60 into the Laval nozzle 20 is still relatively low (0≈Mach number<<1). Only in the region of the nozzle neck 50 does significant acceleration of the gas stream P take place, so that there is a gas flow speed Vo of the gas stream P in the supersonic range (Mach number>1) in the diverging subsection 40.

In order to achieve as high as possible a flow speed of the gas stream P in the subsection 40, as high as possible a gas temperature is set up in the stagnation chamber 60. In order then to avoid the possibility that overheating takes place in the converging subsection 30 of the Laval nozzle 20, and concomitantly deformation or destruction of the Laval nozzle 20, it is clad or coated with a thermal insulation material 100. The thermal insulation material 100 has a thermal conductivity of less than 20 W/Km.

The insulation material 100 may, for example, be formed by one or more of the following ceramic materials or at least also contain one or more of them: porcelains, steatites, cordierite ceramics; aluminum oxide, in particular zirconium-reinforced; aluminum silicate; aluminum titanate; zirconium oxide, in particular stabilized variants; oxides of magnesium, beryllium or titanium; silicon nitride; porous silicon carbide, in particular nitride-bonded or recrystallized.

For example, the cladding in the converging subsection 30 of the Laval nozzle 20 is formed by a conical, in particular frustoconical, insert 110 which is entirely or in part of the thermal insulation material 100 and is placed or inserted into the Laval nozzle 20. The gas stream P is separated from the inner wall 120 of the Laval nozzle 20 by the insert 110, so that the inner wall 120 is thermally protected in the region of the insert 110.

Preferably, the stagnation chamber 60 can be opened on its side on the left or right in FIG. 1, in order to be able to extract the insert 110 from the Laval nozzle 20 in the event of wear and replace it.

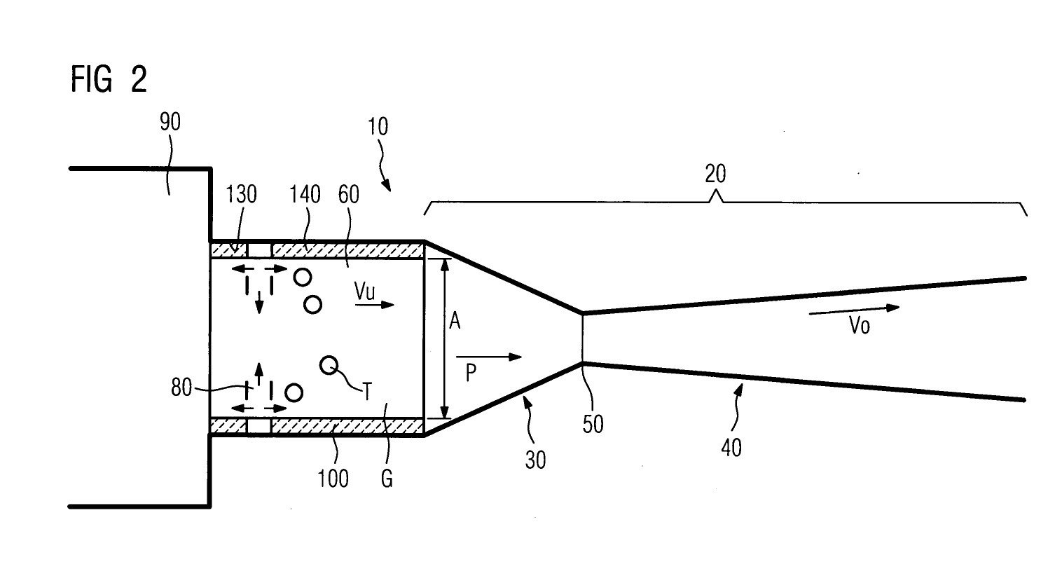

FIG. 2 shows a second exemplary embodiment of a cold gas spraying system 10. In contrast to the first exemplary embodiment according to FIG. 1, the stagnation chamber 60 is thermally protected. Thus, FIG. 2 shows that the inner wall 130 of the stagnation chamber 60 is clad or coated with the thermal insulation material 100. For example, the cladding is formed by an insert 140 which includes the thermal insulation material 100, and rests internally on the inner wall 130. The insert 140 may, for example, be formed by a cylindrical insertion sleeve at least in one section. Preferably, in the event of wear, the insertion sleeve can be replaced from the side of the stagnation chamber 60 on the left or right in FIG. 2.

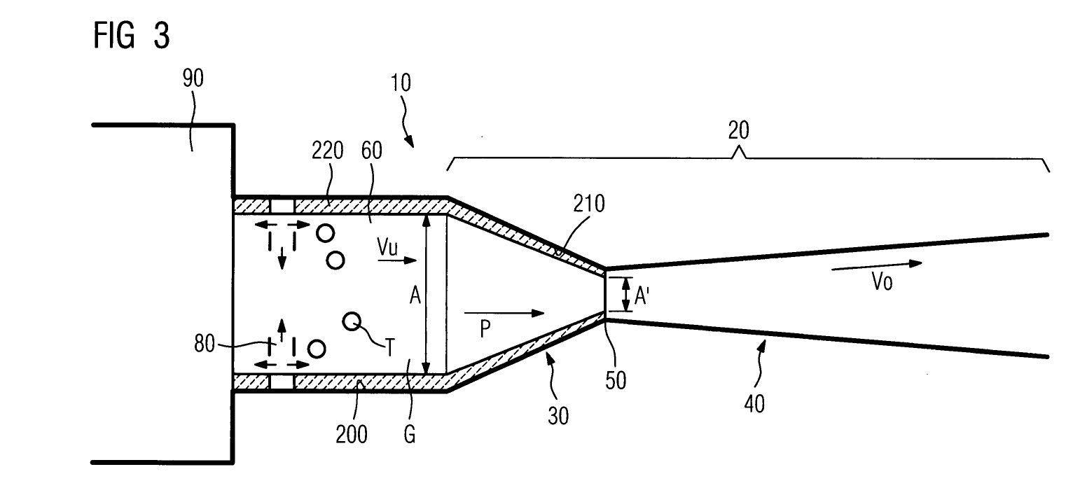

FIG. 3 shows another exemplary embodiment of a cold gas spraying system 10. In the exemplary embodiment, that inner wall section 200 of the stagnation chamber 60 which adjoins the Laval nozzle 20 and the inner wall section 210 of the converging subsection 30 of the Laval nozzle 20 are thermally insulated. For example, the two inner wall sections 200 and 210 are clad with an insert 220 in the form of a sleeve or insertion sleeve, which has been inserted via the stagnation chamber 60 into the latter and into the Laval nozzle 20. Preferably, the insertion sleeve 220 is replaceable, so that it can be replaced in the event of wear. As shown in FIG. 3, the insertion sleeve 220 is cylindrical in one section and conical in another section, the cylindrical section being placed or inserted in the stagnation chamber 60 and the conical section being placed or inserted in the converging subsection 40 of the Laval nozzle 20.

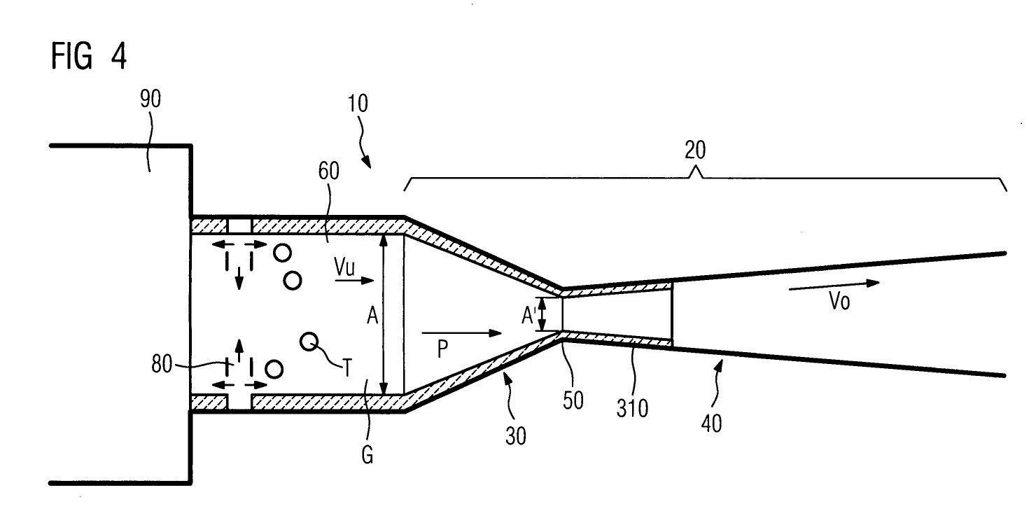

FIG. 4 shows an exemplary embodiment of the cold gas spraying system 10, in which the stagnation chamber 60, the converging subsection 30 of the Laval nozzle 20, the nozzle neck 50 and a lower section 310 of the diverging subsection 40 of the Laval nozzle 20 are thermally insulated. For example a coating of a thermal insulation material, which has a thermal conductivity of less than 20 W/Km, is applied onto the sections. As an alternative, the stagnation chamber 60, the subsection 30, the nozzle neck 50 and the lower section 310 may also be solidly of a thermal insulation material which has a thermal conductivity of less than 20 W/Km.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A cold gas spraying system, comprising:
a gas heating device;
a stagnation chamber connected indirectly or directly to the gas heating device;
a Laval nozzle having an input connected to the stagnation chamber and an output discharging a gas stream containing particles a supersonic speed; and
at least one thermally protected section, downstream in a gas flow direction from the gas heating device, formed of, or clad on an inner wall with, a ceramic insulation material having a thermal conductivity of less than 20 W/Km.

13. The cold gas spraying system as claimed in claim 12, wherein the ceramic insulation material includes at least one of porcelains, steatites, cordierite ceramics, zirconium-reinforced aluminum oxide, aluminum silicate, aluminum titanate, stabilized variants of zirconium oxide, magnesium oxide, beryllium oxide, titanium oxide, silicon nitride, and nitride-bonded or recrystallized porous silicon carbide.

14. The cold gas spraying system as claimed in claim 13, wherein the at least one thermally protected section is protected by an insert formed at least in part of the ceramic insulation material and separating the inner wall from the gas stream.

15. The cold gas spraying system as claimed in claim 14, wherein at least a part of the insert is formed by a frustoconical sleeve in a converging subsection of the Laval nozzle.

16. The cold gas spraying system as claimed in claim 13, wherein the at least one thermally protected section is protected by a coating of the insulation material, applied on the inner wall of the at least one thermally protected section and separating the inner wall from the gas stream.

17. The cold gas spraying system as claimed in claim 16, wherein the at least one thermally protected section lies in a converging subsection of the Laval nozzle.

18. The cold gas spraying system as claimed in claim 13, wherein the at least one thermally protected section lies at least partly in the stagnation chamber.

19. The cold gas spraying system as claimed in claim 18, wherein the at least one thermally protected section extends from the stagnation chamber out of the stagnation chamber into a converging part of the Laval nozzle.

20. The cold gas spraying system as claimed in claim 19, wherein the at least one thermally protected section is protected by an inserted sleeve having a cylindrical section placed in the stagnation chamber and a frustoconical section placed in the converging part of the Laval nozzle.

21. The cold gas spraying system as claimed in claim 20, wherein the thermally protected section extends at least into a neck of the Laval nozzle.

22. The cold gas spraying system as claimed in claim 21,
wherein the stagnation chamber can be opened, and
wherein the inserted sleeve and the stagnation chamber are configured so that the inserted sleeve can be taken out of the stagnation chamber and replaced.
